(19) United States
(12) Patent Application Publication
(10) Pub. No.: US 2010/0280792 A1
(43) Pub. Date: Nov. 4, 2010

(54) PORTABLE DEVICE AND METHOD FOR MEASUREMENT AND CALCULATION OF DYNAMIC PARAMETERS OF PEDESTRIAN LOCOMOTION

(76) Inventors: Miguel Fernando Paiva Velhote Correia, Porto (PT); Sérgio Reis Cunha, Porto (PT)

Correspondence Address: KENEALY VAIDYA LLP, 515 EAST BRADDOCK RD SUITE B, Alexandria, VA, 22314, US

(21) Appl. No.: 12/812,438

(22) PCT Filed: Sep. 25, 2008
(86) PCT No.: PCT/IB08/53913

§ 371 Date: Jul. 9, 2010

(30) Foreign Application Priority Data
Jan. 17, 2008 (PT) 103933

(51) Int. Cl. G01C 22/00

(52) U.S. Cl. 702/160

(57) ABSTRACT

The disclosed subject matter relates to a portable and autonomous device and corresponding method for the measurement, recording and calculation of dynamic parameters of the pedestrian locomotion of its bearer. The method hereby disclosed allows determining the distance effectively travelled, the velocity of displacement and the pressures exerted on the contact surface of the lower limb with the ground, during the pedestrian locomotion, according to its different phases. Through sensors strategically placed, accelerations, angular velocities and pressures are measured and recorded on the control unit. The device disclosed includes a processing unit that implements the method disclosed and a communication unit to transfer to an external unit the calculated parameters. The disclosed invention can be used in applications that involve monitoring parameters of the locomotion activity or daily ambulation of its bearer, in the areas of health and sports or in any physical and occupational activities.

### FIELD OF THE INVENTION

The invention disclosed hereafter responds to the need of measuring, recording and analyzing parameters of pedestrian locomotion, in an autonomous and rigorous way, during its performance outside clinical or laboratory environments, for long periods of time spanning several hours, being applicable for example in the areas of health, sports or any physical or occupational activities.

### BACKGROUND OF THE INVENTION

Pedestrian locomotion is a complex activity performed by a large number of animal species, among them the human being. This physical activity involves many structural elements of the body of the specimen or individual, such as the skeleton and associated muscles and, in particular in the human being, his lower limbs. Furthermore, it is an individualized and characteristic activity that allows distinguishing species, genders, or identifying a specific individual, as well as its attitudes, emotions or pathologies. The measurement of parameters characterizing locomotion is currently performed with i) highly complex and expensive equipments in gait analysis laboratories, under controlled conditions constraining for the individual or ii) portable inexpensive equipments for daily use, with reduce reliability and limited functionality. In this category of portable equipments there are the so called pedometers, many of which do no more than just simply count the bearer's number of steps.

More recently, some proposals have arisen of devices with a few increased functionalities, such as estimates of traveled distance, of average velocity of locomotion, of time intervals and kind of activity and energy expenditure.

The documents US005955667A and US006301964B1 describe a system for movement analysis consisting on a device, comprising a pair of accelerometers and a tilt sensor, and a calculation method of kinematic parameters of human gait, namely velocities and distances, through the integration of acceleration signals with drift compensation. Yet, for the correct determination of the traveled distance, the invention disclosed by those documents proposes to include and extra accelerometer with axis parallel to one of the previously referred. Additionally, the drift compensation described requires the correct detection of the instant of impact of the foot on the ground, incremented by an interval of 0.1 s, and in the estimation of the impact force from the signal of the accelerometer at that instant and the body mass of the individual. If, on one hand, one can argue on the generality of the 0.1 s value, on the other hand, the acceleration of impact can easily be contaminated with noise and its detection difficult, in particular in cases when the individual drags the foot on the ground.

The document US20030009308A1 discloses an instrumented insole with a combination of sensors that include solid state gyroscopes and force sensing resistors, along with a programmable microcontroller, non volatile memory and radiofrequency communication for storage and transmission of angular velocity and plantar forces data acquired during gait. That document proposes the placement of all components in the insole, which can cause discomfort in its use, and it does not propose the inclusion of accelerometers or its use in combination with the remaining sensors. Furthermore, the document does not disclose any methods whatsoever for determining kinematic or kinetic parameters, such as the travelling velocity, or the traveled distance, or other indicators of locomotion activity.

The document US006836744B1 discloses a portable system for the analysis of human gait. This system comprises one unit for acquiring movements of the heel, one unit for acquiring movements of the lower leg, one acquisition unit for plantar pressures, one processing unit, one display unit and an enclosure. The different components perform the acquisition and processing of accelerations, angular velocities, tridimensional orientations and positions to determine pronation or supination of the foot, its inversion or eversion, the central line of pressure and eventual excessive or abnormal loads on the foot sole. The system requires a considerable number of components being, for example, recommended an insole with twelve force sensors, as well as two units, each one with three accelerometers and three gyroscopes oriented according to three axis, for acquiring the tridimensional movement in the lower leg and heel, and additionally a portable display component.

Finally, the document US20050010139A1 refers to a body movement monitoring device based on autonomous and synchronized units of sensors for acquiring movements of the for body segments of the lower limbs of a subject. The method disclosed uses a complex calculation method of Wavelet Transforms to determine the length, time interval and velocity of stride of an individual. The total number of sensors, proposed to achieve the intended results, is high, since the method, disclosed by that document, demands for a total of twelve accelerometers and twelve gyroscopes distributed en for autonomous units.

The devices and techniques referred to above seek to solve specific problems of human gait analysis making use of several different kinds of sensors of kinematic parameters. The simplest ones perform step counting, such as pedometers, and calculate estimates of the remaining parameters through calibration procedures where the user himself indicates the typical stride length or travels a previously known distance, this way allowing only mean results to be obtained that can easily be distorted. The remaining devices that measure accelerations do not adequately sole the calibration problem and the drifts in the signals integration, while those devices that measure angular velocities and/or plantar pressures do not use such information to improve the reliability of the system in the resolution of the traveled distance, for instances. Additionally, these last class of devices propose the use an unnecessarily high number of sensors to attain the desired results.

### SUMMARY AND ADVANTAGES OF THE INVENTION

The invention disclosed herewith consists in a portable and autonomous device and corresponding method for the measurement, recording and calculation of dynamic parameters of the pedestrian locomotion of its bearer (1).

The method developed and disclosed hereafter allows determining the effectively traveled distance, the travelling velocities and the pressures exerted on the contact surface of the lower limb (2) with the ground during pedestrian locomotion.

Through sensors strategically placed (3, 4) on the lower limb (2) and on the contact surface with the ground, the accelerations, the angular velocities and the pressures are acquired, which are then recorded on the control unit (5). The device, implementing the referred method, constitutes a single autonomous unit comprising a minimum set of sensors (3, 4): at least two accelerometers (14), at least one gyroscope (15) and at least two force sensors (16); a processing unit (10), a memory unit (9), an energy unit (8) and communications unit (11, 12), this last one to communicate to an external, unit (6) the calculated parameters.

The main usage of the invention is in monitoring parameters of the locomotion activity or daily ambulation of its bearer (1), through measurement of kinematic parameters on a plane of movement (18), determination of the pedestrian locomotion cycle and identification of its different phases.

The technical problem the invention solves consists in determining rigorously the distance effectively traveled and the instantaneous travelling velocities, as well as the time spawns and support pressures in relevant anatomical points (17) for the identification of the different locomotion phases and detection of abnormal conditions. Through the combined usage of the different physical quantities referred above, a self calibration procedure of the sensors (3, 4) with real time compensation of drifts in the kinematics signals, achieved by incorporating the moments of immobility of the lower limb (2) on the ground and by processing the kinematic and kinetic signals with an optimal Kalman filter (28), one obtains improved performances and functionalities that are not achieved by other methods or devices.

The main advantages of the invention hereby disclosed are:
the possibility to implement the method described in a single autonomous unit with a minimum set of sensors (3, 4), namely: two accelerometers (14), one gyroscope (15) and two force sensors (16);
the measurement of kinematics parameters in a plane of movement (18), allowing to determine the pedestrian locomotion cycle and identification of its different phases;
the combined measurement of dynamic parameters such as support pressures in relevant anatomical points (17), for the identification of locomotion phases and detection of abnormal or pathological conditions;
the self calibration procedure of the sensors (3, 4) with real time compensation of drifts in the kinematic signals, by incorporating of knowledge of the moments of immobility of the lower limb (2) on the ground and by processing the kinematic and kinetic signals with an optimal Kalman filter (28);
the identification of uninterrupted sequences of steps for characterization of their joint time, kinematic and kinetic parameters;
the storage of information in an aggregate and compact form allowing periods of prolonged acquisition and analysis.

### BRIEF DESCRIPTION OF FIGURES

For an easier understanding of the invention, the following figures were attached, which represent preferential realizations of the invention that, however, do not limit the scope of this invention.

FIG. 1: Example of the invention application and its usage by a human subject, in which:
(1) depicts the bearer of the device,
(2) represents the lower limb of the bearer (1),
(3) and (4) represent the sensors,
(5) represents the control unit and
(6) represents an external unit.

FIG. 2: Block diagram with the modules constituents of the autonomous unit, in which:
(7) represents the energy supply unit,
(8) represents the energy regulation module,
(9) represents the non volatile memory module,
(10) represents the processing module,
(11) represents the wireless communication module,
(12) represents the wired communication module (e.g. serial communication),
(13) represents the signal conditioning and conversion circuits,
(14) represents the two accelerometers,
(15) represents the gyroscope and
(16) represents the two force sensors.

FIG. 3: Example of relevant anatomical points for placement of force sensors (16), in which:
(17) represent force measurement points.

FIG. 4: Reference coordinate system for sensors orientation in order to measure kinematics parameters on a plane of movement, in which:
(18) represents the plane of movement,
(19) represents vertical direction,
(20) represents horizontal and vertical axis, and
(21) represents the articulation of support for the lower limb (2).

FIG. 5: Dataflow diagram of the method for processing the signals measured by the sensors (3, 4) and calculation of dynamic parameters of pedestrian locomotion, in which:
(22) represents a low-pass filter,
(23) represents an integrator,
(24) represents a rotation matrix,
(25) represents two integrators and
(26) represents two integrators.

FIG. 6: Dataflow diagram of the applied Kalman filter to obtain instantaneous velocities and distances, in which:
(27) represents a threshold detector,
(28) represents a Kalman filter,
(29) represents a multiplier,
(30) represents state observation in the Kalman filter,
(31) represents the innovations in the Kalman filter,
(32) represents the corrections in the Kalman filter,
(33) represents the state variables,
(34) represents the offset in the limb's angle (2),
(35) represents the offset in vertical acceleration,
(36) represents the error in horizontal velocity and
(37) represents the error in vertical velocity.

FIG. 7: Charts demonstrating the succession of pressure signals in the support surface and pattern of angular movement of the lower limb (2), and time evolution of instantaneous velocities and distances.

### DETAILED DESCRIPTION OF THE INVENTION

The invention disclosed herewith is composed of a portable autonomous device and a method that embodies it.

The device consists in an electronic circuit, depicted in FIG. 2, containing as fundamental components at least two accelerometers (14) preferably oriented parallel to a plane of movement (18) and with orthogonal sensing axis; one gyroscope (15) whose sensing axis is preferably perpendicular to the same plan of movement; a minimum set of at least two force sensors (16) to measure the plantar pressure in strategic points on the contact surface of the lower limb (17) with the ground; one processing module (10) composed by a microprocessor and signal conditioning and conversion circuits (13) and communication with the outside, performed preferably by a wireless communication module (11) or wired communication module (e.g. serial communication) (12) and one energy supply module (7), embodied, for example, by a battery preferably rechargeable. The device may additionally include an energy regulation module (8), a non volatile memory module (9) for information storage and force sensors (16), preferably piezo-resistive, in a quantity equal or higher than two, for measurement of pressure in several anatomic or pathologically relevant points (17).

In the realization of the method disclosed herewith, the two accelerometers (14) and the gyroscope (15) constitute the minimum set of inertial sensors required to correctly measure the locomotion movement of an individual, and should be placed in a manner that is solid with his lower limb (2), such that the plane of movement (18) defined by the axis of the accelerometers be parallel to the sagital plane of the individual.

The force sensors (16), placed in such a manner to measure the pressure value exerted on the contact surface with the ground, provide information indicating when the lower limb (2) is set on the ground. This information, together with the inertial sensors signals, is processed in real time to determine the locomotion movement, on said plane, according to the method described hereafter.

The gyroscope (15) measurements are filtered by a low-pass filter (22), with cut-off frequency below the frequencies characterizing the locomotion movement, in order to determine the offset of this sensor. Thus, its calibration is automatic. The instantaneous differences ω relative to said drift are integrated (23) in time to obtain the angle θ of relative orientation to the horizontal and vertical axis of the referential defined by the accelerometers (14) axis, being this angle therefore in direct correspondence with the angle formed by the lower limb (2), with which the device is solidly attached, relative to vertical (19). This angle differs from the real angle by an offset Δθ (34) which the system determines as described below.

Alongside, the measurements of the two accelerometers (14) are converted to a referential differing of the sensors referential by a rotation (24) and such that one of the axis is horizontal and the other vertical (20). Said rotation directly follows from the corrected angle θ, of the lower limb (2) under observation, obtained from the difference between the values, given by said integration of the gyroscope (15) measurements, and the offset Δθ (34) such as it is known at each instant. Now in the new referential, to the vertical component is added the offset in acceleration ΔA_v (35), to be continuously estimated as described below, and where the measurements are integrated (25) to obtain the horizontal and vertical velocities. After adding the errors in velocity (36 and 37) estimated by the Kalman filter, the velocity values are once, again integrated (26) in order to obtain the horizontal and vertical components of position along the said plane of movement (18).

Simultaneously, the offsets of the angle Δθ (34) and of the vertical acceleration ΔA_v (35), as well as the errors in horizontal and vertical velocity (36, 37), are processed as state variables of a Kalman filter, according to the diagram depicted in FIG. 6. The design of said Kalman filter corresponds to what is usually called in the literature as extended discrete Kalman filter. Said Kalman filter combines the system state evolution with the observation that the lower limb (2) velocity is null. Every time the force sensors (16) indicate the lower limb (2) is in contact with the ground, exerting a pressure p above a threshold (27) enough to be reasonable to consider said limb is static on the ground, the condition that said lower limb (2) has zero velocity is supplied to the Kalman filter (28), in the form of state observation (30). As particular feature in the design of said Kalman filter is the fact the innovations (31) are not performed at a constant rate, but rather being conditioned to the evident occurrence of the above said condition. As such it is possible to perform corrections (32) to all four state variables (33) (the two offsets (34, 35) and the two velocity errors (36, 37)), such that all calibrations of the inertial sensors are carried out automatically, and the movement description in said plane of movement (18) is kept under high levels of accuracy.

As mentioned in the previous paragraph, what constitutes the state of said Kalman filter (28) are the offset in the angle (34) of the limb under observation, the offset in vertical acceleration (35) and the errors in horizontal (36) and vertical (37) velocities. Likewise, it is possible to use a different set of variables that can be transformed in this one (and vice-versa) through transformations that just depend on the variables and measurements obtained from the inertial sensors.

The dynamics of the horizontal and vertical velocities, excluding the errors in state evolution, correspond to what was exposed previously regarding the depiction of the dataflow diagram (FIG. 5). The dynamics of the offsets of the angle and vertical acceleration is null:

$$\{ \begin{matrix}{Δθ}_{k + 1} = {Δθ}_{k} \\ {ΔA\_v}_{k + 1} = Δ {A\_ v}_{k} \\ {V\_ h}_{k + 1} = {V\_ h}_{k} + ( {A\_ x}_{k} cos ( θ {c}_{k} ) + {A\_ y}_{k} sin ( θ {c}_{k} ) ) dt \\ {V\_ v}_{k + 1} = {V\_ v}_{k} + [ - {A\_ x}_{k} sin ( θ {c}_{k} ) + {A\_ y}_{k} cos ( θ {c}_{k} ) - g - Δ {A\_ v}_{k} ] dt\end{matrix}$$

where Δθ, ΔA_v, V_h and V_v are, respectively, the offsets in the angle (34) and vertical acceleration (35) and the horizontal (36) and vertical (37) velocities. The accelerations A_x and A_y are the accelerometers (14) measurements, θc is the measured angle, corrected by the offset Δθ, and g is the gravity acceleration. The covariance P matrix of this state vector has an evolution determined by the linearization of the above expressions:

Pₖ₊₁=AₖPₖAₖ^{T}+Q,

such that:

$$A = [ \begin{matrix}1 & 0 & 0 & 0 \\ 0 & 1 & 0 & 0 \\ a & b & 1 & 0 \\ c & d & 0 & 1\end{matrix} ] , \\ \{ \begin{matrix}a = ( {A\_ x}_{k} sin ( θ {c}_{k} ) - {A\_ y}_{k} cos ( θ {c}_{k} ) ) dt \\ b = 0 \\ c = ( {A\_ x}_{k} cos ( θ {c}_{k} ) - {A\_ y}_{k} sin ( θ {c}_{k} ) ) dt \\ d = - dt\end{matrix} \\ Q = [ \begin{matrix}{0.02}^{2} & 0 & 0 & 0 \\ 0 & {0.002}^{2} & 0 & 0 \\ 0 & 0 & {0.02}^{2} & 0 \\ 0 & 0 & 0 & {0.02}^{2}\end{matrix} ]$$

where the values of the Q coefficients are referred for an update rate dt of 100 cycles per second. The optimal Kalman gain for state update is computed, as usual, from:

Kₖ=PₖH^{T}(HPₖH^{T}+R)⁻¹.

The state observations (30) are made on the velocity of the lower limb (2) contact surface with the ground, which corresponds to the horizontal and vertical velocities of the system (navigation centre of the inertial sensors), corrected by the angular velocity measured by the gyroscope (15) (corrected in turn from its drift), multiplied by the arm b (29) corresponding to the length between the location of the inertial sensors and the support joint (21) of the lower limb. Noting that the system is not very sensitive to the accuracy of said arm's length, an approximated constant value can be used regardless of the bearer (1) characteristics and the placement of the device. The matrix H, representing the first derivative of the observation function in the Kalman filter, is given by:

$$H = [ \begin{matrix}0 & 0 & 1 & 0 \\ 0 & 0 & 0 & 1\end{matrix} ] .$$

The covariance matrix of the state observations is given by:

$$R = [ \begin{matrix}{0.05}^{2} & 0 \\ 0 & {0.05}^{2}\end{matrix} ] .$$

The values of the coefficients in matrices Q and R are merely examples, serving simply to provide an order of magnitude for the same, when considering the International Units System for all magnitudes.

The set of four state variables presented above constitutes the minimum set that ensures the quality of the movement estimate, ensuring therefore the design of this Kalman filter is optimal for this application.

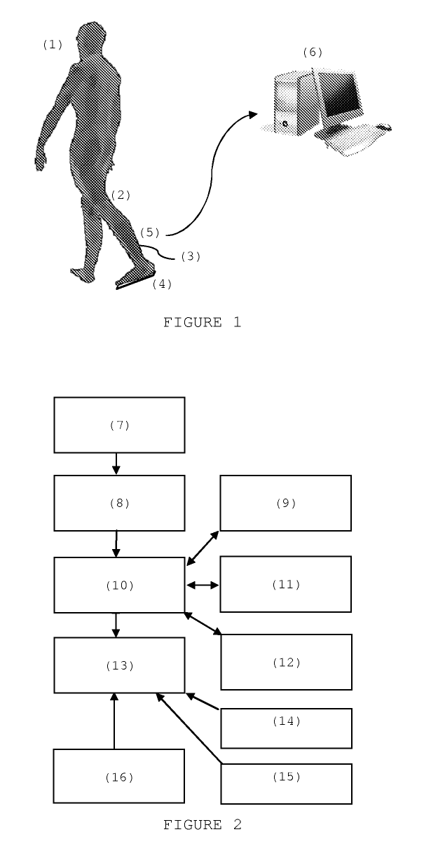

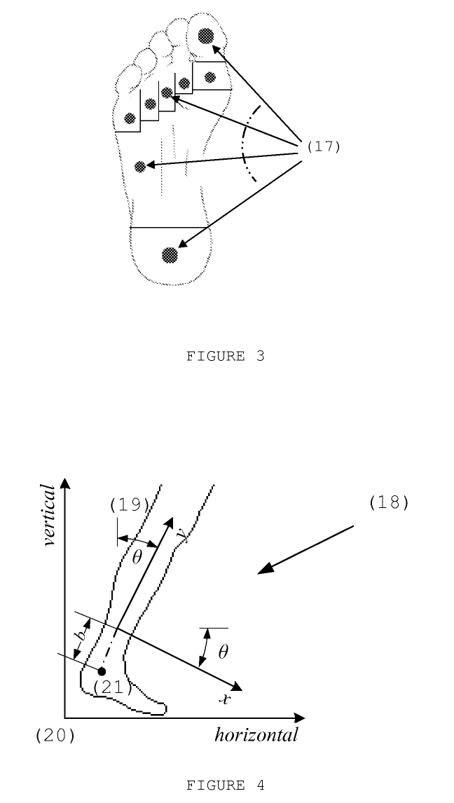

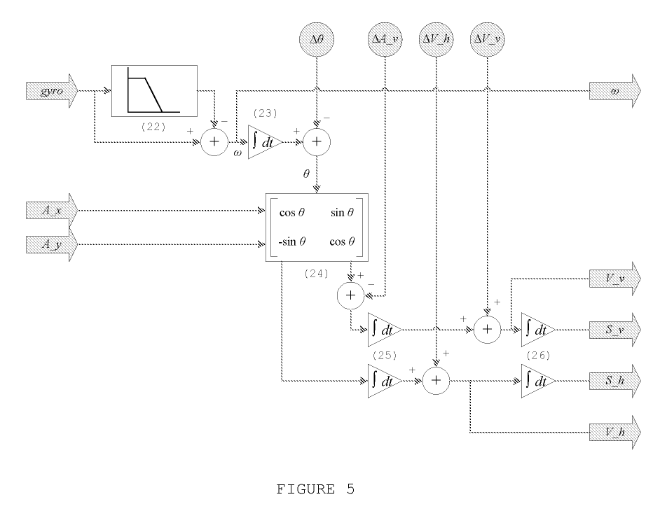

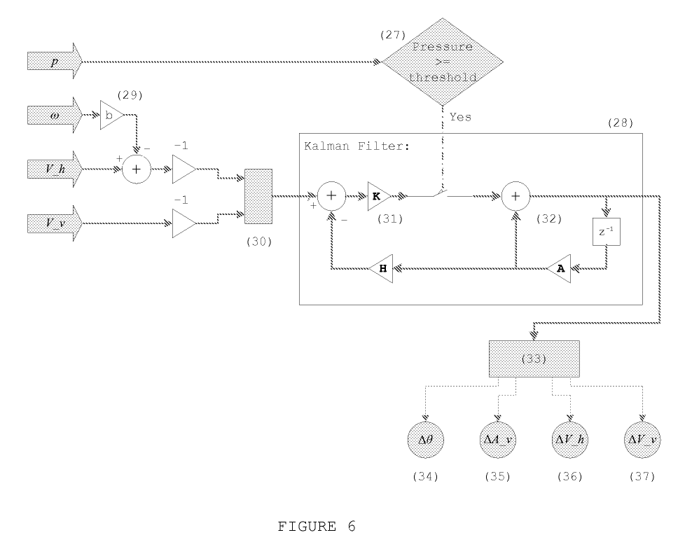

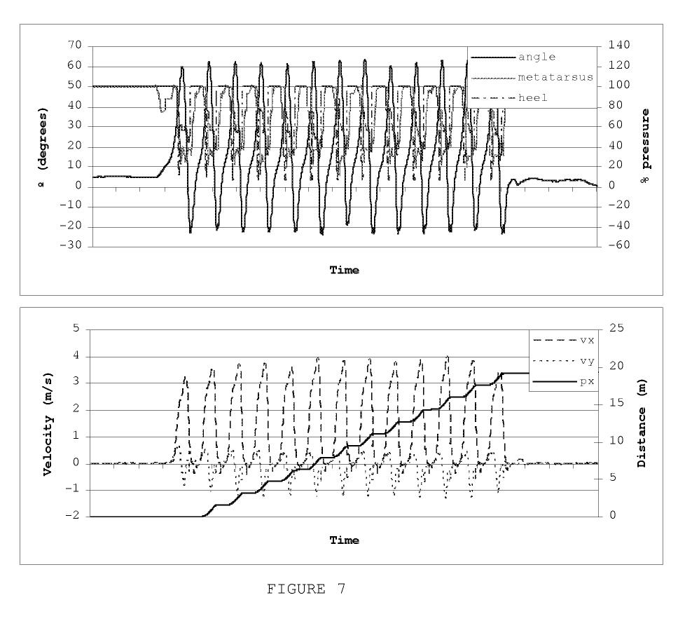

A series of activations of the force sensors (16) in the instants of contact of the lower limb (2) surface with the ground, preferably associated with a pattern of angular movement, measured by the device and method hereby disclosed, allows determining automatically each elementary cycle of pedestrian locomotion (FIG. 7). As a consequence, it also allows segmenting the performed measurements by cycle (relative to each step) and sequences of cycles. Said sequences correspond to series of steps taken in a continuous and uninterruptable way. Thus, it is possible to obtain aggregated measurements to said series, such as the number os steps, the traveled distance, the average stride length and duration, the average amplitude of movement of the lower limb(2), as well as the possibility to characterize the format of the average stride in terms of durations of its constituent phases.

Besides determining the instants in time during which the lower limb (2) is effectively laid on the ground, the force sensors (16) also measure at every instant the pressure exerted in each of the areas of the support surface in the locations (17) where said sensors have been placed (that can be adjusted as needed on each application of the device). Consequently, the device allows analysing automatically and in real time the pressure made in each of the several critical points on the support surface of the lower limb (17) according to the phase of the pedestrian locomotion cycle. To this end, the values recorded are the average and maximum pressures at each location, with reference to the mean instant, within the locomotion cycle, when the maximums occur.

Both the values characteristic of locomotion obtained from the inertial sensors, and the pressures referred to the locomotion cycle, described in the previous paragraph, can be recorded in memory for later analysis. Automatically computing these parameters on the device itself considerably reduces the memory requirements, when compared to directly storing the sensors signals sampled uniformly in time. In doing so, it is possible to store in non volatile memory of the device, if available, information relative to at least a week of the individual's activity to whom the device was applied to. It also allows the analysis of pedestrian locomotion, including the pressure distribution in the lower limb (2) surface, to occur in the daily environment of the individual and over a sufficient period of time in order to cover the most diverse conditions of activity of the limb under study.

The communication with an external unit (6), preferably made by a wireless communication module (11) or a wired communication module (e.g. serial communication (12), is essential for immediate transmission in real time of the information obtained by the method here by disclosed or for its deferred transmission, when previously stored in non volatile memory (9) on the device, to a nearby computer. Such data are easily catalogued according to the individual, respective limb (2) and period of time of observation. Through an appropriate software tool, said data can be presented efficiently to an user, allowing to extract analytical knowledge on the locomotion and daily ambulation of each individual under study.

From the point of view of usage, the device and method disclose herewith present themselves as particularly easy to deploy and use, since calibration is not required, and are oriented to determining automatically the set of characterizing parameters of pedestrian locomotion that constitute the majority of the needs of a wide range of applications in the domain of biomechanical analysis. Indeed, its performance goes far beyond the devices that only count the number of steps and estimate the traveled distance by establishing a priori the average step length. It allows the analysis of the locomotion cycle, because it completely measures it, extracting from it, automatically and in real time, the most relevant information for analysis. Being portable and with the ability to operate unattended for long periods of time allows it to be used on the daily living environment of each individual, increasing significantly the utility of the acquired information.

It must remain clear that the above description o implementation of this method and device for the measurement and calculation of dynamic parameters of pedestrian locomotion, are simply possible examples of implementation, merely to set a clear understanding of the principles of the invention. Changes and modifications may be made to the above without substantially deviate from the spirit and principle of the invention, according to some examples provided below.

In one example of implementation, eight thin film piezo-resistive force sensors, two accelerometers and one gyroscope in micromechanical technology integrated in an electronic circuit were used. These sensors were connected to a 16 bit microcontroller, equipped with analogue to digital conversion and serial communication, connected to a flash memory card, a USB communication module and a wireless communication module, according to the Bluetooth standard. The electronic circuit, thus built, was programmed with the method previously described and placed on the lower limb (2) of several human subjects according to the provisions depicted in FIG. 1, FIG. 3 and FIG. 4. There were measurements of locomotion parameters, as exemplified in the charts in FIG. 7

1. Method for the measurement and calculation of dynamical parameters of pedestrian locomotion comprising:
filtering measurements of angular velocity of a single-axis gyroscope by means of a low-pass filter, in order to continuously determine the drift of this sensor;
integrating the difference, between the gyroscope signal and said drift, obtaining the angle, θ, of orientation with respect to the horizontal and vertical axis, of the referential defined by the axes of at least two single-axis accelerometers, or analogously at least one double-axis accelerometer;
converting the accelerometers measurements to a new referential by a rotation, said rotation obtained from said angle, θ, of orientation, where, in the new referential, one of the axis is horizontal and the other vertical;
integrating the accelerometer measurements over time to obtain the horizontal and vertical velocities;
integrating the measurements of horizontal and vertical velocities in order to obtain the horizontal and vertical components of position;
estimating the offset, Δθ, of the angle θ, and the vertical offset, ΔA_v, of the vertical acceleration A_v, or the horizontal offset, ΔA_h, of the horizontal acceleration A_h, and the errors, ΔV_h and ΔV_v, respectively, in horizontal and vertical velocities, V_h and V_v; with said offsets and errors being used as state variables of an extended discrete Kalman filter;
updating the state of said Kalman filter every time two or more force sensors indicate the lower limb is in contact with the ground, exerting a pressure p above a threshold high enough to consider that said limb's velocity is zero, in the form of state observation of null velocities V_h and V_v;
recording the series of activations of the force sensors to determine the locomotion cycles;
recording force sensor data and the instants when they occur within the locomotion cycle for the detection of eventual abnormalities.

2. Method for the measurement and calculation of dynamical parameters of pedestrian locomotion, according to claim 1, wherein the accelerometers and the gyroscope are placed in a manner that is solid with the lower limb of the bearer, such that the plane of movement, defined by the axes of the accelerometers, is parallel to the sagital plane of the individual.

3. Method for the measurement and calculation of dynamical parameters of pedestrian locomotion, according to claim 1, wherein the low-pass filter has a cut-off frequency below the frequencies that characterize the bearer locomotion movement, compensating the drift in angular velocity of the lower limb as measured by the gyroscope.

4. Method for the measurement and calculation of dynamical parameters of pedestrian locomotion, according to claim 1, wherein, automatically and in real time, the pressure exerted in each of the several critical points on the support surface of the lower limb is analyzed, according to the phases of the pedestrian locomotion cycle, where the values determined are the time averages and maximum of sampled pressures at each location, also recording the instant, within the locomotion cycle, when the pressures occurred.

5. Method for the measurement and calculation of dynamical parameters of pedestrian locomotion, according to claim 1, wherein the number of steps, the traveled distance, the velocity and the acceleration of the lower limb, the average stride length and duration, the average amplitude of movement of the lower limb, as well as the format of the average stride in terms of the durations of each of its constituents phases, are recorded or transmitted in real-time.

6. Method for the measurement and calculation of dynamical parameters of pedestrian locomotion, according to claim 5, wherein the referred parameters are calculated for each continuous uninterrupted sequence of locomotion cycles.

7. Device for the measurement and calculation of dynamical parameters of pedestrian locomotion, comprising the following elements:
two single-axis accelerometers, or analogously one double-axis accelerometer;
one single-axis gyroscope;
at least two force sensors, suitable for determining when there is full contact of the lower limb with the ground
one recursive self-calibrating estimator of corrections to the horizontal and vertical velocities of the device, said estimator being self-calibrating when there is full contact of the lower limb with the ground and when, therefore, velocities are null.

8. Device for the measurement and calculation of dynamical parameters of pedestrian locomotion according to claim 7, further comprising:
a rotation operator connected to the accelerometers and gyroscope, suitable for converting their output data to horizontal and vertical directions;
a first set of two integrators, connected to the accelerometers, which output the estimated horizontal and vertical velocities of the device;
a second set of two integrators, connected to the output of the first set, which output the estimated horizontal and vertical positions;
an extended kalman filter, as the said recursive self-calibrating estimator.

9. Device for the measurement and calculation of dynamical parameters of pedestrian locomotion, according to claim 7, wherein the accelerometers axes are oriented parallel to a plane of movement and aligned orthogonally to each other.

10. Device for the measurement and calculation of dynamical parameters of pedestrian locomotion, according to claim 7, wherein the sensing axis of the gyroscope is perpendicular to the plane of movement.

11. Device for the measurement and calculation of dynamical parameters of pedestrian locomotion, according to claim 7, further including force sensors, for measurement of pressure in several anatomic or pathologically relevant points.

12. Device for the measurement and calculation of dynamical parameters of pedestrian locomotion, according to claim 11, wherein the force sensors are piezo-resistive.

13. Device for the measurement and calculation of dynamical parameters of pedestrian locomotion, according to claim 7 wherein the two accelerometers and the gyroscope are placed in a manner that is solid with the lower limb of the bearer, such that the plane of movement defined by the axes of the accelerometers is parallel to the sagital plane of the individual.

14. Device for the measurement and calculation of dynamical parameters of pedestrian locomotion, according to claim 7, further comprising a data processing module to automatically and in real time analyse the pressure exerted in each of the several critical points on the support surface of the lower limb, according to the phases of the pedestrian locomotion cycle, where the values determined are the profile, average and maximum pressures at each location, with reference to the mean instant, within the locomotion cycle, when said pressures occurred.

15. Device for the measurement and calculation of dynamical parameters of pedestrian locomotion, according to claim 14, wherein the data processing module is supplying the number of steps, the traveled distance, the velocity and the acceleration of the lower limb, the average stride length and duration, the average amplitude of movement of the lower limb, as well as the format of the average stride in terms of the durations of each of its constituent phases.

16. Device for the measurement and calculation of dynamical parameters of pedestrian locomotion, according to claim 7 further comprising means of communication with an external unit, by a wired or wireless communication module.
